(19) United States
(12) Patent Application Publication
(10) Pub. No.: US 2024/0430807 A1
(43) Pub. Date: Dec. 26, 2024

(54) DISCONTINUOUS RECEPTION DRX PARAMETER CONFIGURATION METHOD AND APPARATUS, TERMINAL, AND NETWORK-SIDE DEVICE

(71) Applicant: VIVO MOBILE COMMUNICATION CO., LTD., Dongguan (CN)

(72) Inventors: Zuolong YING, Dongguan (CN); Xin QU, Dongguan (CN); Dongru LI, Dongguan (CN)

(73) Assignee: VIVO MOBILE COMMUNICATION CO., LTD., Dongguan (CN)

(21) Appl. No.: 18/830,484

(22) Filed: Sep. 10, 2024

Related U.S. Application Data
(63) Continuation of application No. PCT/CN2023/080010, filed on Mar. 7, 2023.

(30) Foreign Application Priority Data
Mar. 11, 2022 (CN) 202210238584.0

(51) Int. Cl. H04W 52/02; H04W 76/28

(52) U.S. Cl. CPC H04W 52/0261; H04W 76/28

(57) ABSTRACT

A Discontinuous Reception (DRX) parameter configuration method and apparatus, a terminal, and a network-side device, are provided. The DRX parameter configuration method includes: receiving, by a terminal, DRX configuration information of a Wake-Up Signal (WUS); and performing, by the terminal based on the DRX configuration information, WUS monitoring during DRX on duration; where the DRX configuration information includes at least one of the following: DRX start point configuration information; DRX on duration configuration information; and DRX cycle configuration information.

### CROSS-REFERENCE TO RELATED APPLICATIONS

This application is a continuation of International Application No. PCT/CN2023/080010, filed on Mar. 7, 2023, which claims priority to Chinese Patent Application No. 202210238584.0, filed Mar. 11, 2022. The entire contents of each of the above-identified applications are expressly incorporated herein by reference.

### TECHNICAL FIELD

This application pertains to the field of communication technology, and specifically relates to a DRX parameter configuration method and apparatus, a terminal, and a network-side device.

### BACKGROUND

The introduction of a Low Power Wake-Up Receiver (LP-WUR) allows a terminal to turn off or hibernate a main communication module under specific circumstances, and to turn on the main communication module when the terminal uses the WUR to receive a Low Power Wake-Up Signal (LP-WUS), thereby effectively reducing power consumption of the terminal. Currently, in a New Radio (NR) system, a terminal needs to monitor low power wake-up signals in real time, so as to determine when to turn on the main communication module. This in turn causes the terminal to stay in a monitoring state, thereby increasing power consumption of the terminal.

### SUMMARY

Embodiments of this application provide a DRX parameter configuration method and apparatus, a terminal, and a network-side device.

According to a first aspect, a DRX parameter configuration method is provided, including:
receiving, by a terminal, DRX configuration information of a wake-up signal WUS; and
performing, by the terminal based on the DRX configuration information, WUS monitoring during DRX on duration; where
the DRX configuration information includes at least one of the following:
DRX start point configuration information;
DRX on duration configuration information; and
DRX cycle configuration information.

According to a second aspect, a DRX parameter configuration method is provided, including:
sending, by a network-side device, DRX configuration information of a WUS to a terminal; where
the DRX configuration information includes at least one of the following:
DRX start point configuration information;
DRX on duration configuration information; and
DRX cycle configuration information.

According to a third aspect, a DRX parameter configuration apparatus is provided, including:
a first receiving module configured to receive DRX configuration information of a wake-up signal WUS; and
an execution module configured to perform, based on the DRX configuration information, WUS monitoring during DRX on duration; where
the DRX configuration information includes at least one of the following:
DRX start point configuration information;
DRX on duration configuration information; and
DRX cycle configuration information.

According to a fourth aspect, a DRX parameter configuration apparatus is provided, including:
a second sending module configured to send DRX configuration information of a WUS to a terminal; where
the DRX configuration information includes at least one of the following:
DRX start point configuration information;
DRX on duration configuration information; and
DRX cycle configuration information.

According to a fifth aspect, a terminal is provided, where the terminal includes a processor and a memory, the memory stores a program or instructions capable of running on the processor, and when the program or instructions are executed by the processor, the steps of the DRX parameter configuration method according to the first aspect are implemented.

According to a sixth aspect, a terminal is provided, including a processor and a communication interface, where the communication interface is configured to receive DRX configuration information of a wake-up signal WUS; and the processor is configured to perform, based on the DRX configuration information, WUS monitoring during DRX on duration; where
the DRX configuration information includes at least one of the following:
DRX start point configuration information;
DRX on duration configuration information; and
DRX cycle configuration information.

According to a seventh aspect, a network-side device is provided, where the network-side device includes a processor and a memory, the memory stores a program or instructions capable of running on the processor, and when the program or instructions are executed by the processor, the steps of the DRX parameter configuration method according to the second aspect are implemented.

According to an eighth aspect, a network-side device is provided, including a processor and a communication interface, where the communication interface is configured to send DRX configuration information of a WUS to a terminal; where
the DRX configuration information includes at least one of the following:
DRX start point configuration information;
DRX on duration configuration information; and
DRX cycle configuration information.

According to a ninth aspect, a communication system is provided, including a terminal and a network-side device, where the terminal is configured to perform the steps of the DRX parameter configuration method according to the first aspect, and the network-side device is configured to perform the steps of the DRX parameter configuration method according to the second aspect.

According to a tenth aspect, a readable storage medium is provided, where a program or instructions are stored on the readable storage medium, and when the program or instructions are executed by a processor, the steps of the DRX parameter configuration method according to the first aspect are implemented, or the steps of the DRX parameter configuration method according to the second aspect are implemented.

According to an eleventh aspect, a chip is provided, where the chip includes a processor and a communication interface, the communication interface is coupled to the processor, and the processor is configured to run a program or instructions to implement the DRX parameter configuration method according to the first aspect, or to implement the DRX parameter configuration method according to the second aspect.

According to a twelfth aspect, a computer program/program product is provided, where the computer program/program product is stored in a storage medium, and the computer program/program product is executed by at least one processor to implement the DRX parameter configuration method according to the first aspect, or to implement the DRX parameter configuration method according to the second aspect.

According to a thirteenth aspect, a communication device is provided, configured to perform the steps of the method according to the first aspect or the steps of the method according to the second aspect.

In the embodiments of this application, the terminal performs, based on the DRX configuration information of the received wake-up signal, wake-up signal monitoring during the DRX on duration, with no need for the terminal to stay in a monitoring state, thereby effectively reducing power consumption of the terminal.

### BRIEF DESCRIPTION OF DRAWINGS

FIG. 1 is a block diagram of a wireless communication system according to some implementations of this application;

FIG. 2a is a block diagram of a terminal according to some implementations of this application;

FIG. 2b is a schematic diagram of a DRX cycle according to some implementations of this application;

FIG. 2c is a schematic diagram of a DRX cycle of a wake-up signal according to some implementations of this application;

FIG. 3 is a flowchart of a DRX parameter configuration method according to some implementations of this application;

FIG. 4a is a first schematic diagram for determining a DRX start point of a WUS according to some implementations of this application;

FIG. 4b is a second schematic diagram for determining a DRX start point of a WUS according to some implementations of this application;

FIG. 4c is a schematic diagram of working principles of a terminal according to some implementations of this application;

FIG. 4d is a third schematic diagram for determining a DRX start point of a WUS according to some implementations of this application;

FIG. 4e is a fourth schematic diagram for determining a DRX start point of a WUS according to some implementations of this application;

FIG. 4f is a fifth schematic diagram for determining a DRX start point of a WUS according to an embodiment of this application;

FIG. 5 is a flowchart of another DRX parameter configuration method according to some implementations of this application;

FIG. 6 is a block diagram of a DRX parameter configuration apparatus according to some implementations of this application;

FIG. 7 is a block diagram of another DRX parameter configuration apparatus according to some implementations of this application;

FIG. 8 is a block diagram of a communication device according to some implementations of this application;

FIG. 9 is a block diagram of a terminal according to some implementations of this application; and

FIG. 10 is a block diagram of a network-side device according to some implementations of this application.

### DETAILED DESCRIPTION

The following describes the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first,” “second,” and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It should be noted that technologies described in the embodiments of this application are not limited to a Long Term Evolution (LTE) or LTE-Advanced (LTE-A) system, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, and NR terms are used in most of the following descriptions, although these technologies may also be applied to other applications than an NR system application, for example, the 6th Generation (6G) communication system.

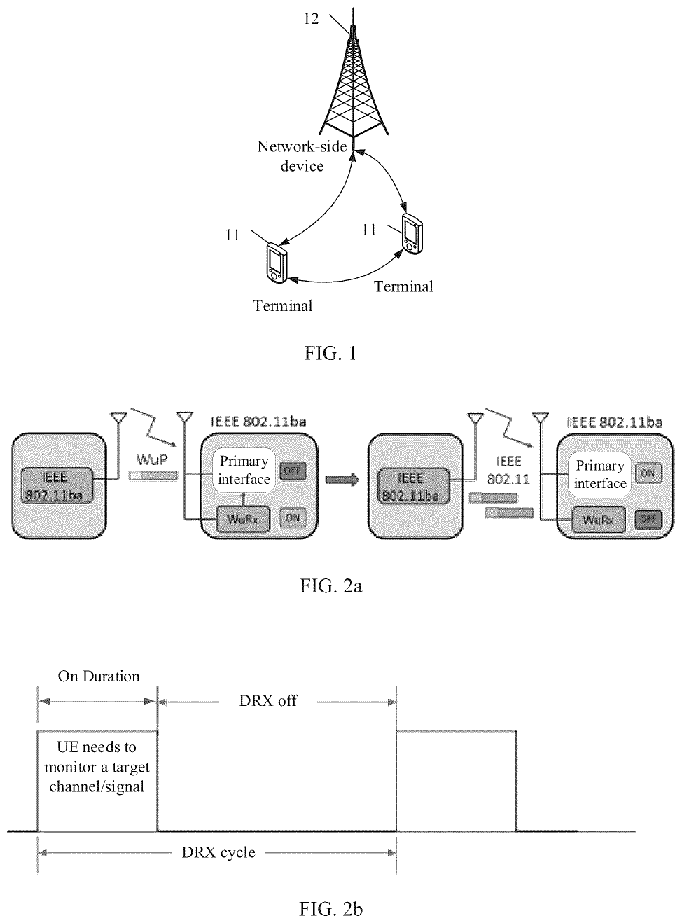

FIG. 1 is a block diagram of a wireless communication system to which an embodiment of this application is applicable. The wireless communication system includes a terminal 11 and a network-side device 12. The terminal 11 may be a terminal-side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart household (home devices with wireless communication functions, such as refrigerators, televisions, washing machines, or furniture), a game console, a personal computer, a teller machine, or a self-service machine. The wearable device includes a smartwatch, a smart band, smart earphones, smart glasses, smart jewelry (a smart bracelet, a smart wrist band, a smart ring, a smart necklace, a smart leglet, a smart anklet, and the like), a smart wristband, smart clothing, or the like. It should be noted that the terminal 11 is not limited to a specific type in the embodiments of this application. The network-side device 12 may include an access network device or a core network device. The access network device can also be called a wireless access network device, a Radio Access Network (RAN), a wireless access network function, or a wireless access network unit. The access network device may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or other suitable terms in the field. Provided that the same technical effect is achieved, the base station is not limited to specific technical terms. It should be noted that in the embodiments of this application, only the base station in the NR system is used as an example, but the specific type of the base station is not limited.

For better understanding, the following explains the related concepts that may be involved in the embodiments of this application.

### (1) Low Power Wake-Up

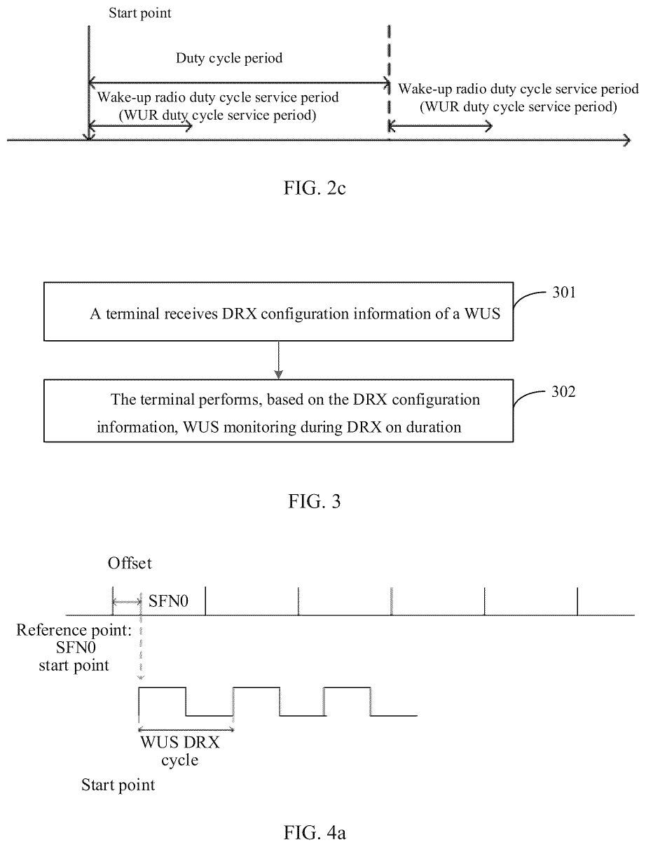

IEEE 802.11ba has designed a Low Power Wake-Up Receiver (LP-WUR), as shown in FIG. 2a. An 802.11 user equipment includes two parts: a primary interface and a wake-up receiver. The primary interface is used for Wi-Fi data transmission and reception, and the wake-up receiver is used to wake up the primary interface. Before woken up, the primary interface is in an off state and does not perform data transmission and reception. The wake-up receiver receives the wake-up signal sent by an 802.11 Wireless Access Point (AP), The wake-up signal may be an On-Off Keying (OOK) modulation signal, so that the wake-up receiver can detect the wake-up signal through envelope detection, which can reduce power consumption to a few hundred microwatts, greatly reducing the power consumption of the 802.11 user equipment.

### (2) DRX Cycle of Low Power Wake-Up Signal

As shown in FIG. 2b, a Discontinuous Reception (DRX) cycle includes “on duration (On Duration)” and “DRX off”. During the “On Duration” time, the UE monitors the target channel/signal, such as the Low Power Wake Up Signal (LP-WUS); during the “DRX off” time, the UE does not monitor the target channel/signal to reduce power consumption.

To further reduce the power consumption of the wake-up receiver, 802.11ba also uses discontinuous reception of the wake-up signal, in which the user equipment and AP determine the cycle, start point, and reception time length of the discontinuous reception of the wake-up signal through the Wake Up Radio (WUR) mode establishment procedure. As shown in FIG. 2c, the user equipment receives the wake-up signal through the wake-up receiver during the duty cycle service period within each duty cycle. The user equipment informs the AP of the lengths of the duty cycle period and the duty cycle service period by sending a Wake-Up Radio mode element (WUR mode element), where the length of the duty cycle service period is less than or equal to the length of the duty cycle period, and the length of the duty cycle service period is greater than or equal to the minimum wake-up time length indicated by the AP. After the AP acknowledges the lengths of the duty cycle period and the duty cycle service period carried in the WUR mode element from the user equipment, the user equipment takes them as the discontinuous reception cycle parameters of the user equipment. In addition, the start point of the duty cycle service period, that is, the start point shown in FIG. 2c, is indicated through the mode element sent by the AP, and the Timing Synchronization Function (TSF) time of the start point is indicated using 64 bits, with the time unit being microseconds.

The following describes in detail the DRX parameter configuration method provided in the embodiments of this application by using some embodiments and application scenarios thereof with reference to the accompanying drawings.

Referring to FIG. 3, FIG. 3 is a flowchart of a DRX parameter configuration method according to an embodiment of this application. The method is executed by a terminal. As shown in FIG. 3, the method includes the following steps.

Step 301. A terminal receives DRX configuration information of a WUS.

The DRX configuration information includes at least one of the following:
DRX start point configuration information;
DRX on duration configuration information; and
DRX cycle configuration information.

In this embodiment of this application, the terminal may receive the DRX configuration information of the WUS from a network-side device.

In some implementations, the DRX configuration information includes at least one of the DRX start point configuration information, the DRX on duration configuration information, and the DRX cycle configuration information. For example, the DRX configuration information includes the DRX start point configuration information, for example, the DRX start point configuration information may include a specific system frame, such as system frame 0, so the terminal can determine the start point of system frame 0 as the DRX start point of the wake-up signal. In some implementations, the DRX configuration information includes the DRX on duration configuration information, where the DRX on duration may be understood as the “On Duration” in the DRX cycle, to be specific, during this “On Duration” time, the terminal can monitor and receive the wake-up signal, so the terminal can monitor and receive the wake-up signal within a determined period of time (On Duration) based on the DRX on duration configuration information. In some implementations, the DRX configuration information may include the DRX cycle configuration information, where the DRX cycle may include the on duration (On Duration) and the off duration (DRX off); In some implementations, the DRX configuration information may include the DRX start point configuration information and the DRX cycle configuration information. In some implementations, the DRX configuration information may include the DRX on duration configuration information and the DRX cycle configuration information. The specific content included in the DRX configuration information may be other possible implementations, which are not exhaustively listed herein.

Step 302. The terminal performs, based on the DRX configuration information, WUS monitoring during DRX on duration.

In this embodiment of this application, after receiving the DRX configuration information of the WUS, the terminal can perform wake-up signal monitoring in a discontinuous reception manner, or perform wake-up signal monitoring during the DRX on duration, based on the DRX configuration information. For example, the DRX configuration information includes the DRX start point configuration information, so the terminal determines the DRX start point based on the DRX start point configuration information, and the terminal can determine when to start wake-up signal monitoring, without a need for the terminal to stay in a monitoring state. For another example, the DRX configuration information includes the DRX on duration configuration information, so the terminal can determine the DRX on duration based on the DRX on duration configuration information, and the terminal can then perform wake-up signal monitoring during the DRX on duration while skip the wake-up signal monitoring during the non-DRX on duration, with no need for the terminal to stay in a monitoring state. In some implementations, the DRX configuration information may be other possible cases, which are not specifically described herein.

In this embodiment of this application, the terminal performs wake-up signal monitoring during the DRX on duration based on the DRX configuration information of the received wake-up signal, with no need for the terminal to stay in a monitoring state, thereby effectively reducing power consumption of the terminal.

In some implementations, the DRX start point configuration information includes at least one of the following:
a system frame;
a superframe, where the superframe includes N system frames, N being an integer greater than or equal to 1;
extended Discontinuous Reception (eDRX) configuration information for paging;
a related parameter of Connected mode DRX (C-DRX) for the terminal; and
a related parameter of a Physical Downlink Control CHannel (PDCCH) that the terminal needs to monitor.

For example, the DRX start point configuration information includes a system frame, so the terminal can determine a DRX start point of the WUS based on a start point of the system frame, for example, determining the start point of the system frames as the DRX start point of the WUS, or determining the DRX start point of the WUS based on the system frame and a preset time offset.

In some implementations, the DRX start point configuration information includes a superframe, for example, the superframe includes 1024 system frames. One system frame is 0.01 seconds, so the superframe is 10.24 seconds. Then the terminal can determine the position corresponding to 10.24 seconds as the DRX start point of the WUS, or determine the DRX start point of the WUS based on the superframe and a preset time offset.

In some implementations, the DRX start point configuration information includes eDRX configuration information for paging, for example, the eDRX configuration information for paging may include a start point of an eDRX cycle, so the terminal can determine the start point of the eDRX cycle as the DRX start point of the WUS. In some implementations, the eDRX configuration information for paging may be other possible cases, which are not described herein.

In some implementations, the DRX start point configuration information includes a related parameter of C-DRX for the terminal, for example, the related parameter of the C-DRX for the terminal may be a long DRX cycle, so the terminal can determine a start point of the long DRX cycle as the DRX start point of the WUS. In some implementations, the related parameter of the C-DRX for the terminal may be other possible cases, which are not described herein.

In some implementations, the DRX start point configuration information includes a related parameter of a PDCCH that the terminal needs to monitor, for example, the related parameter of the PDCCH that the terminal needs to monitor is a time position of a search space in which the PDCCH is located, so the terminal can determine the time position of the search space in which the PDCCH is located as the DRX start point of the WUS. In some implementations, the related parameter of the PDCCH that the terminal needs to monitor may be other possible cases, which are not described herein.

In some implementations, the DRX start point configuration information may include at least one of the above information or parameters, for example, including a system frame and a superframe, or including a system frame and eDRX configuration information for paging, and so on, which are not exhaustively listed in this embodiment.

In this embodiment of this application, in a case that the DRX configuration information includes the DRX start point configuration information, the terminal can determine the DRX start point based on the DRX start point configuration information, and then the terminal can perform WUS monitoring during the DRX on duration based on the DRX start point, to avoid the terminal staying in a WUS monitoring state, thereby effectively reducing power consumption of the terminal.

In some implementations, the performing, by the terminal based on the DRX configuration information, WUS monitoring during DRX on duration includes:
in a case that the DRX start point configuration information includes a system frame, determining, by the terminal, a DRX start point based on at least one of a specific system frame and a first time offset, and performing WUS monitoring during the DRX on duration based on the DRX start point; where
a start point of the first time offset is a start point or an end point of the specific system frame.

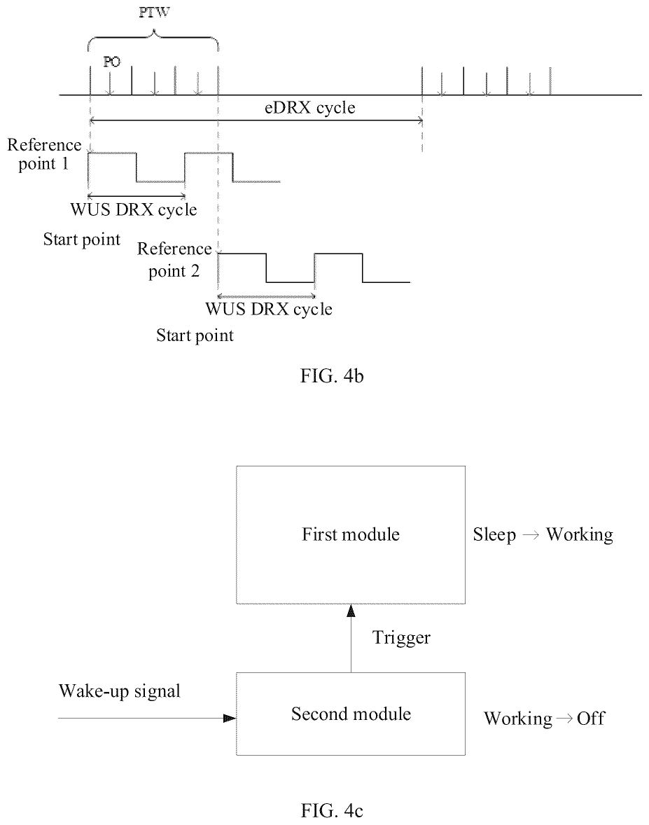

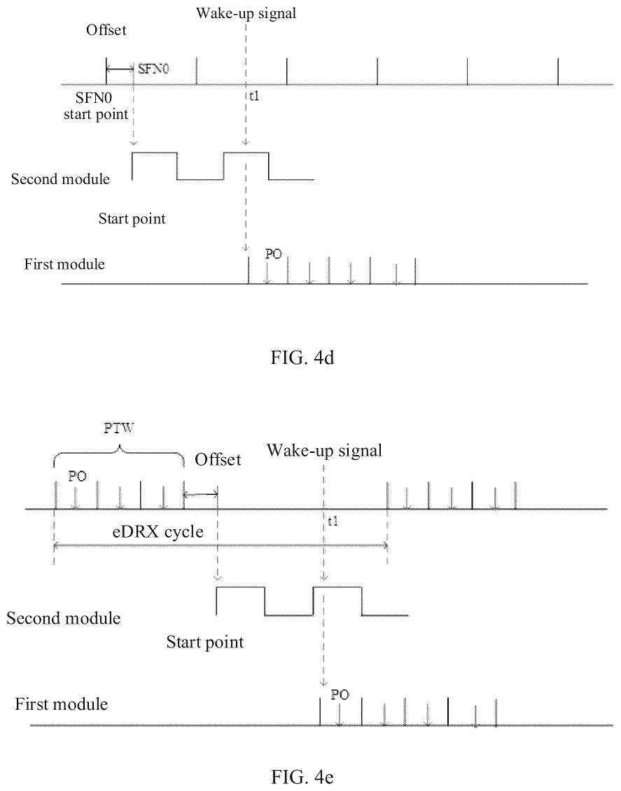

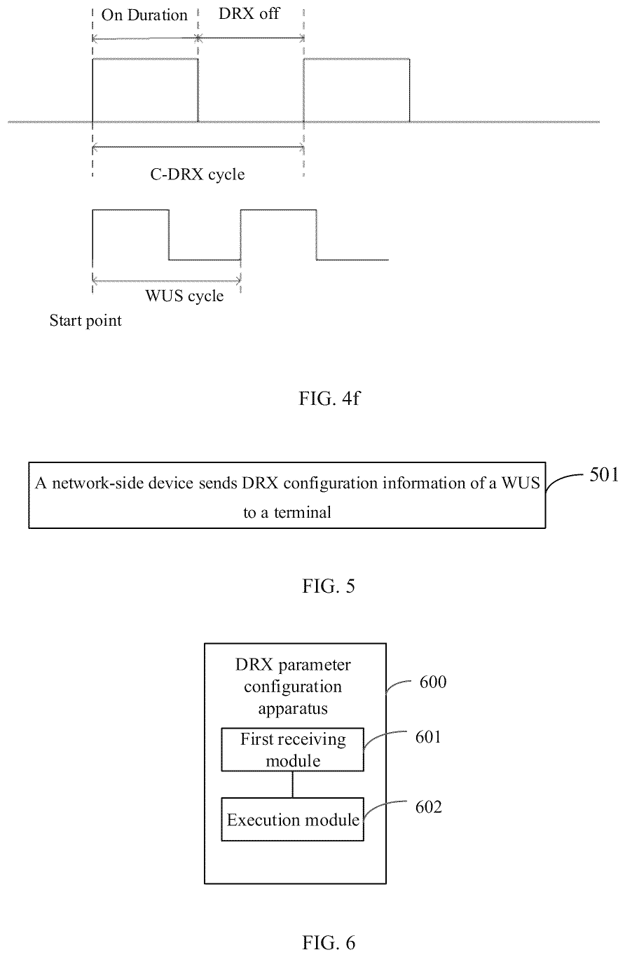

For example, the specific system frame is system frame 0, and the terminal may use the start point or end point of system frame 0 as the start point of said DRX; or the terminal may determine the DRX start point based on system frame 0 and a first time offset. The reference point of the first time offset may be the start point or end point of system frame 0. As shown in FIG. 4a, the offset takes the start point of system frame 0 as the reference point, so the terminal adds the offset to the start point of system frame 0 and determines that point as the DRX start point, and the terminal performs WUS monitoring during the DRX on duration based on this start point.

In this embodiment of this application, the system frame may include at least one of a specific system frame and a first time offset, For example, the network-side device can have at least one of the specific system frame and the first time offset carried in the DRX configuration information to indicate to the terminal, so that the terminal can determine the DRX start point of the WUS based on at least one of the specific system frame and the first time offset, so as to perform WUS monitoring, thereby reducing power consumption of the terminal.

In some implementations, a time unit of the first time offset includes at least one of the following: subframe, slot, symbol, millisecond, system frame, and superframe.

In this embodiment of this application, the DRX start point configuration information may include eDRX configuration information for paging, where the eDRX configuration information includes at least one of the following:
a start point or an end point of an eDRX cycle;
a start point or an end point of a Paging Time Window (PTW) within the eDRX cycle;
a paging frame within the PTW;
a Paging Occasion (PO) within the paging frame within the PTW; and
a start point or an end point of a superframe in which the paging occasion is located.

For example, the eDRX configuration information includes a start point or an end point of the eDRX cycle, so the terminal can determine the start point or the end point of the eDRX cycle as the DRX start point. In some implementations, the eDRX configuration information includes a start point or an end point of a PTW within the eDRX cycle, so the terminal can determine the start point or the end point of the PTW within the eDRX cycle as the DRX start point. In some implementations, the eDRX configuration information includes a Paging Frame (PF) within the PTW, so the terminal can determine the DRX start point based on the PF, for example, using a start point of the PF as the DRX start point. In some implementations, the eDRX configuration information includes a PO within the paging frame within the PTW, so the terminal can determine the PO within the paging frame within the PTW as the DRX start point. In some implementations, the eDRX configuration information includes a start point or an end point of a superframe in which the PO is located, so the terminal determines the start point or the end point of the superframe in which the PO is located as the DRX start point. It can be understood that the eDRX configuration information includes at least one of the above information, and the specific content included in the eDRX configuration information can be other possible cases, which are not exhaustively listed herein.

It should be noted that the eDRX configuration information may be configured to the terminal by the network-side device, and the terminal determines the DRX start point based on the eDRX configuration information, so as to start WUS monitoring during the DRX on duration based on the DRX start point, with no need for the terminal to stay in a WUS monitoring state, thereby effectively reducing power consumption of the terminal.

In some implementations, the performing, by the terminal based on the DRX configuration information, WUS monitoring during DRX on duration includes:
in a case that the DRX start point configuration information includes the eDRX configuration information, determining, by the terminal, a first start point of DRX based on the eDRX configuration information, and performing WUS monitoring during the DRX on duration based on the first start point.

In this embodiment of this application, if the DRX start point configuration information received by the terminal includes the eDRX configuration information, such as the start point of the eDRX cycle, the terminal can use the start point of the eDRX cycle as the first start point of the DRX, so that the terminal can determine when the DRX on duration starts, and the terminal performs WUS monitoring during the DRX on duration based on the first start point, with no need for the terminal to stay in a monitoring state. Certainly, the specific content included in the eDRX configuration information may be other possible cases, which are not listed herein.

Further, the method further includes:
adjusting, by the terminal based on a second time offset, the first start point of the DRX to a second start point, and performing WUS monitoring during the DRX on duration based on the second start point.

In this embodiment of this application, after the terminal determines the first start point of the DRX of the WUS based on at least one of the above eDRX configuration information, the terminal can further adjust the first start point of the DRX to the second start point based on the second time offset, so that the terminal performs WUS monitoring during the DRX on duration based on the second start point.

For example, referring to FIG. 4b, reference point 1 is the start point of the PTW within the eDRX cycle, and the terminal determines this reference point 1 as the DRX start point (that is, the first start point) for WUS monitoring. Reference point 2 is the end point of the PTW within the eDRX cycle, and the terminal can adjust the DRX start point for WUS monitoring to this reference point 2 (that is, the second start point). In some implementations, the terminal can determine the second start point by adding an offset to the first start point, and then adjust the start point of the DRX. In this way, the terminal can flexibly adjust the DRX start point of the WUS, allowing the terminal to perform WUS monitoring more flexibly.

In some implementations, a time unit of the second time offset includes at least one of the following: quantity of the eDRX cycles, slot, symbol, millisecond, frame, and superframe.

In this embodiment of this application, the DRX start point configuration information may further include a related parameter of C-DRX for the terminal, where the related parameter of the C-DRX for the terminal includes at least one of the following:
a start point of the DRX on duration;
a long DRX cycle; and
a short DRX cycle.

For example, the related parameter of the C-DRX for the terminal includes a start point of the DRX on duration, so the terminal can use start point of the DRX on duration as the DRX start point of the WUS; or, the related parameter of the C-DRX for the terminal includes a long DRX cycle or a short DRX cycle, so the terminal can use a start point of the long DRX cycle or the short DRX cycle as the DRX start point of the WUS, so as to perform WUS monitoring. In some implementations, the related parameter of the C-DRX for the terminal may in some implementations include at least one of the above information, which is not exhaustively listed herein.

In some implementations, the DRX start point configuration information may include a related parameter of a PDCCH that the terminal needs to monitor, where the related parameter of the PDCCH that the terminal needs to monitor includes at least one of the following:
a time position of a search space in which the PDCCH is located; and
a cycle of the search space in which the PDCCH is located.

For example, the related parameter of the PDCCH that the terminal needs to monitor includes a time position of a search space in which the PDCCH is located, so the terminal can determine the time positions of the search space in which the PDCCH is located as the DRX start point of the WUS; or, the related parameter of the PDCCH that the terminal needs to monitor includes a cycle of the search space in which the PDCCH is located, so the terminal can determine a start point of the cycle of the search space in which the PDCCH is located as the DRX start point of the WUS.

It should be noted that specific information content of the DRX start point configuration information, such as the system frame, superframe, and eDRX configuration information for paging, can be configured by the network-side device to the terminal, so that the terminal can determine the DRX start point of the WUS based on such information content, and perform WUS monitoring during the DRX on duration, thereby reducing power consumption of the terminal.

In some implementations, different WUS types are associated with respective DRX configuration information.

It should be noted that in a case of multiple WUS types, different WUS types may be associated with different DRX configuration information, or different WUS types may be associated with the same DRX configuration information, or one WUS type may be associated with multiple different DRX configuration information. For example, the WUS types include WUS type 1, WUS type 2, and WUS type 3, and these three WUS types are associated with different DRX configuration information, or WUS type 1 and WUS type 2 can be associated with the same DRX configuration information, and WUS type 3 can be associated with another DRX configuration information.

In some implementations, the network-side device and the terminal can pre-agree on the DRX configuration information associated with each WUS type, so that the terminal can determine corresponding DRX configuration information based on the WUS type, such as different DRX start points for different WUS types or different DRX cycles for different WUS types. This enables the terminal to more flexibly monitor different types of WUS based on different DRXs, improving communication flexibility of the terminal and helping to further reduce power consumption of the terminal.

In some implementations, the WUS type is associated with at least one of the following: a WUS sequence, a WUS format, a WUS frame structure, and a WUS-occupied band. In other words, different WUS types can refer to different WUS sequences, different WUS formats, different WUS frame structures, different WUS-occupied bands, or the like.

In some implementations, before the performing, by the terminal based on the DRX configuration information, WUS monitoring during DRX on duration, the method may further include:
determining, by the terminal based on a WUS type, DRX configuration information associated with the WUS type.

In this embodiment of this application, the network-side device may pre-agree with the terminal on an association between WUS types and respective associated DRX configuration information, or the network-side device sends the association to the terminal in advance, so that the terminal can determine, based on the WUS type, the DRX configuration information associated with the WUS type, and further perform WUS monitoring during corresponding DRX on duration based on the DRX configuration information associated with the WUS type. This can effectively improve the flexibility in monitoring different types of WUS by the terminal.

In this embodiment of this application, the DRX configuration information of the WUS includes configuration information of at least one DRX of the WUS, and a quantity of configuration information of the at least one DRX is related to a terminal capability of the terminal. For example, based on the terminal capability, the DRX configuration information of the WUS sent by the network-side device to the terminal includes the configuration information of at least one DRX, so that the terminal can perform WUS monitoring during on duration of the at least one DRX based on the configuration information of the at least one DRX.

In some implementations, the performing, by the terminal based on the DRX configuration information, WUS monitoring during DRX on duration includes:
performing, by the terminal based on the configuration information of the at least one DRX, WUS monitoring during on duration of the at least one DRX.

For example, the configuration information of the at least one DRX includes configuration information of two DRXs, and the configuration information of these two DRXs includes DRX start point information, and the start point information of the two DRXs is different, so the terminal can perform, based on start points of these two DRXs, WUS monitoring during on durations of the DRXs starting at different times. In this way, the terminal can effectively utilize its terminal capability to perform WUS monitoring during the on duration of at least one DRX, allowing the terminal to perform WUS monitoring more flexibly.

It should be noted that the terminal can receive only one DRX configuration information of the WUS, that is, the terminal does not expect to receive more than one DRX configuration information of the WUS.

In some implementations, before the receiving, by a terminal, DRX configuration information of a WUS, the method further includes:
sending, by the terminal, assistance information to a network-side device, where the assistance information includes DRX configuration information of the WUS preferred by the terminal.

In this embodiment of this application, the terminal can first send the assistance information to the network-side device to report the DRX configuration of the WUS preferred by the terminal to the network-side device through the assistance information, so that the network-side device can targetedly configure, based on the received assistance information, the DRX configuration information of the WUS preferred by the terminal, making the DRX configuration of the WUS more flexible.

For better understanding of the technical solutions provided by the embodiments of this application, several specific embodiments are provided below for illustration.

### Embodiment 1

Referring to FIG. 4c, the terminal mainly includes two modules: a first module can perform paging message monitoring and Radio Resource Management (RRM) measurement according to the DRX cycle, and the second module performs wake-up signal monitoring. When downlink data arrives, a sending end (the network-side device, such as a base station) sends a wake-up signal. After the second module has detected the wake-up signal, it determines, based on identification information, whether the wake-up signal belongs to the terminal. If so, the second module triggers the first module to perform paging signal monitoring, that is, the first module enters a working state from a sleep state. At this time, the second module enters an off state from a working state.

### Embodiment 2

Referring to FIG. 4d, with reference to Embodiment 1, the first module of the UE first performs paging channel monitoring, and when system frame 0 (SFN0) is detected, triggers the second module after a specified time offset based on the protocol-configured time offset, meaning that the start point of the DRX is SFN0+offset. The second module starts wake-up signal monitoring based on the DRX cycle, and the sending end sends a wake-up signal in advance before sending data. After a wake-up signal is detected at time t1, the second module parses identification information to determine whether it belongs to the terminal. If so, the terminal triggers the first module, and the first module enters a working state to perform paging signal monitoring.

### Embodiment 3

Referring to FIG. 4e, after the first module is configured with eDRX, the first module performs paging message monitoring within the PTW window, looking for PO. After the PTW ends, the first module enters a long sleep state. Since the eDRX sleep state lasts long, if data arrives during this period, it is likely to cause high data latency. In FIG. 4e, the DRX of the WUS has its start point associated with PTW end time, and is turned on after a specified time offset (offset), that is, the DRX start point is PTW end time+offset. The terminal performs wake-up signal monitoring based on the DRX cycle. When a wake-up signal arrives during on duration of the second module, the terminal triggers the first module to perform paging message monitoring.

### Embodiment 4

Referring to FIG. 4f, when the terminal is in a connected state, the DRX start point of the WUS can be related to the parameter of connected mode C-DRX for the terminal, for example, the DRX start point is related to start time of onDuration Timer for PDCCH monitoring by the terminal. In FIG. 4f, the DRX start point is the start point of the onDuration for PDCCH monitoring by the terminal.

Referring to FIG. 5, FIG. 5 is a flowchart of another DRX parameter configuration method according to an embodiment of this application. The method is executed by a network-side device. As shown in FIG. 5, the method includes the following steps.

Step 501. A network-side device sends DRX configuration information of a WUS to a terminal.

The DRX configuration information includes at least one of the following:
DRX start point configuration information;
DRX on duration configuration information; and
DRX cycle configuration information.

In this embodiment of this application, at least one of the DRX start point configuration information, the DRX on duration configuration information, and the DRX cycle configuration information can be configured by the network-side device to the terminal, so that the terminal can perform, based on the DRX configuration information, wake-up signal monitoring during the DRX on duration. For specific information content of the DRX configuration information, reference may be made to the specific description of the terminal-side embodiment, which is not repeated in this embodiment.

In some implementations, the DRX start point configuration information includes at least one of the following:
a system frame;
a superframe, where the superframe includes N system frames, N being an integer greater than or equal to 1;
extended discontinuous reception eDRX configuration information for paging;
a related parameter of connected mode discontinuous reception C-DRX for the terminal; and
a related parameter of a PDCCH that the terminal needs to monitor.

In some implementations, in a case that the DRX start point configuration information includes a system frame, the DRX start point configuration information includes at least one of a specific system frame and a first time offset; where a start point of the first time offset is a start point or an end point of the specific system frame.

In some implementations, a time unit of the first time offset includes at least one of the following: subframe, slot, symbol, millisecond, system frame, and superframe.

In this embodiment of this application, the eDRX configuration information includes at least one of the following:
a start point or an end point of an eDRX cycle;
the start point or the end point of the PTW within the eDRX cycle;
a paging frame within the PTW;
a paging occasion within the paging frame within the PTW; and
a start point or an end point of a superframe in which the paging occasion is located.

In some implementations, the related parameter of the C-DRX for the terminal includes at least one of the following:
a start point of the DRX on duration;
a long DRX cycle; and
a short DRX cycle.

In some implementations, the related parameter of the PDCCH that the terminal needs to monitor includes at least one of the following:
a time position of a search space in which the PDCCH is located; and
a cycle of the search space in which the PDCCH is located.

In this embodiment of this application, different WUS types are associated with respective DRX configuration information.

In some implementations, the WUS type is associated with at least one of the following: a WUS sequence, a WUS format, a WUS frame structure, and a WUS-occupied band.

In some implementations, the DRX configuration information of the WUS includes configuration information of at least one DRX of the WUS, and a quantity of configuration information of the at least one DRX is related to a terminal capability of the terminal.

In some implementations, before the sending, by a network-side device, DRX configuration information of a WUS to a terminal, the method further includes: receiving, by the network-side device, assistance information sent by the terminal, where the assistance information includes DRX configuration information of the WUS preferred by the terminal.

That is, the terminal can first send the assistance information to the network-side device to report the DRX configuration of the WUS preferred by the terminal to the network-side device through the assistance information, so that the network-side device can targetedly configure, based on the received assistance information, the DRX configuration information of the WUS preferred by the terminal, making the DRX configuration of the WUS more flexible.

It should be noted that the DRX parameter configuration method provided in this embodiment of this application is executed by the network-side device. For the related concepts and specific processes in the embodiments of this application, reference may be made to the descriptions in the foregoing terminal-side method embodiments. To avoid repetition, details are not described in this embodiment again.

In this embodiment of this application, the network-side device can send the DRX configuration information of the WUS to the terminal, so that the terminal can perform, based on the DRX configuration information, WUS monitoring during the DRX on duration, with no need for the terminal to stay in a monitoring state, thereby effectively reducing power consumption of the terminal.

The DRX parameter configuration method provided in this embodiment of this application may be executed by a DRX parameter configuration apparatus. This embodiment of this application uses the DRX parameter configuration apparatus executing the DRX parameter configuration method as an example to describe the DRX parameter configuration apparatus provided in the embodiments of this application.

Referring to FIG. 6, FIG. 6 is a structural diagram of a DRX parameter configuration apparatus according to an embodiment of this application. As shown in FIG. 6, the DRX parameter configuration apparatus 600 includes:
a first receiving module 601 configured to receive DRX configuration information of a wake-up signal WUS; and
an execution module 602 configured to perform, based on the DRX configuration information, WUS monitoring during DRX on duration; where
the DRX configuration information includes at least one of the following:
DRX start point configuration information;
DRX on duration configuration information; and
DRX cycle configuration information.

In some implementations, the DRX start point configuration information includes at least one of the following:
a system frame;
a superframe, where the superframe includes N system frames, N being an integer greater than or equal to 1;
extended discontinuous reception eDRX configuration information for paging;
a related parameter of connected mode discontinuous reception C-DRX for the apparatus; and
a related parameter of a physical downlink control channel PDCCH that the apparatus needs to monitor.

In some implementations, in a case that the DRX start point configuration information includes a system frame, the execution module 602 is further configured to:
determine a DRX start point based on at least one of a specific system frame and a first time offset, and perform WUS monitoring during the DRX on duration based on the DRX start point; where
a start point of the first time offset is a start point or an end point of the specific system frame.

In some implementations, a time unit of the first time offset includes at least one of the following: subframe, slot, symbol, millisecond, system frame, and superframe.

In some implementations, the eDRX configuration information includes at least one of the following:
a start point or an end point of an eDRX cycle;
a start point or an end point of a paging time window PTW within the eDRX cycle;
a paging frame within the PTW;
a paging occasion within the paging frame within the PTW; and
a start point or an end point of a superframe in which the paging occasion is located.

In some implementations, in a case that the DRX start point configuration information includes the eDRX configuration information, the execution module 602 is further configured to:
determine a first start point of DRX based on the eDRX configuration information, and perform WUS monitoring during the DRX on duration based on the first start point.

In some implementations, the execution module 602 is further configured to:
adjust the first start point of the DRX to a second start point based on a second time offset, and perform WUS monitoring during the DRX on duration based on the second start point.

In some implementations, a time unit of the second time offset includes at least one of the following: quantity of the eDRX cycles, slot, symbol, millisecond, frame, and superframe.

In some implementations, the related parameter of the C-DRX for the apparatus includes at least one of the following:
a start point of the DRX on duration;
a long DRX cycle; and
a short DRX cycle.

In some implementations, the related parameter of the PDCCH that the apparatus needs to monitor includes at least one of the following:
a time position of a search space in which the PDCCH is located; and
a cycle of the search space in which the PDCCH is located.

In some implementations, different WUS types are associated with respective DRX configuration information.

In some implementations, the apparatus further includes:
a determining module configured to determine, based on a WUS type, DRX configuration information associated with the WUS type.

In some implementations, the WUS type is associated with at least one of the following: a WUS sequence, a WUS format, a WUS frame structure, and a WUS-occupied band.

In some implementations, the DRX configuration information of the WUS includes configuration information of at least one DRX of the WUS, and a quantity of configuration information of the at least one DRX is related to a capability of the apparatus.

In some implementations, the execution module 602 is further configured to:
perform, based on the configuration information of the at least one DRX, WUS monitoring during on duration of the at least one DRX.

In some implementations, the apparatus further includes:
a first sending module configured to send assistance information to a network-side device, where the assistance information includes DRX configuration information of the WUS preferred by the terminal.

In this embodiment of this application, the apparatus performs, based on the DRX configuration information of the received wake-up signal, WUS monitoring during the DRX on duration, with no need to stay in a monitoring state, thereby effectively reducing power consumption of the apparatus.

The DRX parameter configuration apparatus in this embodiment of this application may be an electronic device, such as an electronic device with an operating system; or may be a component in the electronic device, such as an integrated circuit or a chip. The electronic device may be a terminal or another device different from the terminal. For example, the terminal may include but is not limited to the types of the terminal 11 listed above, and the another device may be a server, a Network Attached Storage (NAS), or the like, which are not specifically limited in the embodiments of this application.

The DRX parameter configuration apparatus provided in this embodiment of this application can implement various processes implemented by the terminal in the method embodiments described in FIG. 3 to FIG. 4f. To avoid repetition, details are not described herein again.

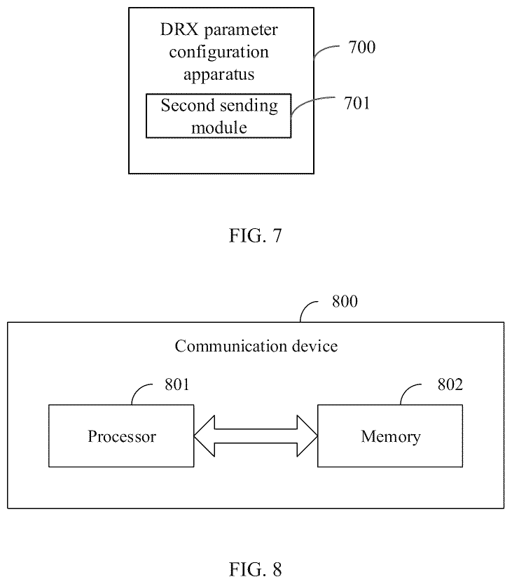

Referring to FIG. 7, FIG. 7 is a structural diagram of another DRX parameter configuration apparatus according to an embodiment of this application. As shown in FIG. 7, the DRX parameter configuration apparatus 700 includes:
a second sending module 701 configured to send DRX configuration information of a WUS to a terminal; where
the DRX configuration information includes at least one of the following:
DRX start point configuration information;
DRX on duration configuration information; and
DRX cycle configuration information.

In some implementations, the DRX start point configuration information includes at least one of the following:
a system frame;
a superframe, where the superframe includes N system frames, N being an integer greater than or equal to 1;
extended discontinuous reception eDRX configuration information for paging;
a related parameter of connected mode discontinuous reception C-DRX for the terminal; and
a related parameter of a physical downlink control channel PDCCH that the terminal needs to monitor.

In some implementations, in a case that the DRX start point configuration information includes a system frame, the DRX start point configuration information includes at least one of a specific system frame and a first time offset; where
a start point of the first time offset is a start point or an end point of the specific system frame.

In some implementations, a time unit of the first time offset includes at least one of the following: subframe, slot, symbol, millisecond, system frame, and superframe.

In some implementations, the eDRX configuration information includes at least one of the following:
a start point or an end point of an eDRX cycle;
a start point or an end point of a paging time window PTW within the eDRX cycle;
a paging frame within the PTW;
a paging occasion within the paging frame within the PTW; and
a start point or an end point of a superframe in which the paging occasion is located.

In some implementations, the related parameter of the C-DRX for the terminal includes at least one of the following:
a start point of the DRX on duration;
a long DRX cycle; and
a short DRX cycle.

In some implementations, the related parameter of the PDCCH that the terminal needs to monitor includes at least one of the following:
a time position of a search space in which the PDCCH is located; and
a cycle of the search space in which the PDCCH is located.

In some implementations, different WUS types are associated with respective DRX configuration information.

In some implementations, the WUS type is associated with at least one of the following: a WUS sequence, a WUS format, a WUS frame structure, and a WUS-occupied band.

In some implementations, the DRX configuration information of the WUS includes configuration information of at least one DRX of the WUS, and a quantity of configuration information of the at least one DRX is related to a terminal capability of the terminal.

In some implementations, the apparatus further includes:
a second receiving module configured to receive assistance information sent by the terminal, where the assistance information includes DRX configuration information of the WUS preferred by the terminal.

In this embodiment of this application, the apparatus can send the DRX configuration information of the WUS to the terminal, so that the terminal can perform, based on the DRX configuration information, WUS monitoring during the DRX on duration, with no need for the terminal to stay in a monitoring state, thereby effectively reducing power consumption of the terminal.

The DRX parameter configuration apparatus provided in this embodiment of this application can implement various processes implemented by the network-side device in the method embodiment described in FIG. 5. To avoid repetition, details are not described herein again.

In some implementations, as shown in FIG. 8, an embodiment of this application further provides a communication device 800 including a processor 801 and a memory 802, where the memory 802 stores a program or instructions capable of running on the processor 801. For example, in a case that the communication device 800 is a terminal, when the program or instructions are executed by the processor 801, various steps of the DRX parameter configuration method embodiment described in FIG. 3 are implemented. In a case that the communication device 800 is a network-side device, when the program or instructions are executed by the processor 801, various steps of the DRX parameter configuration method embodiment described in FIG. 5 are implemented. To avoid repetition, details are not described herein again.

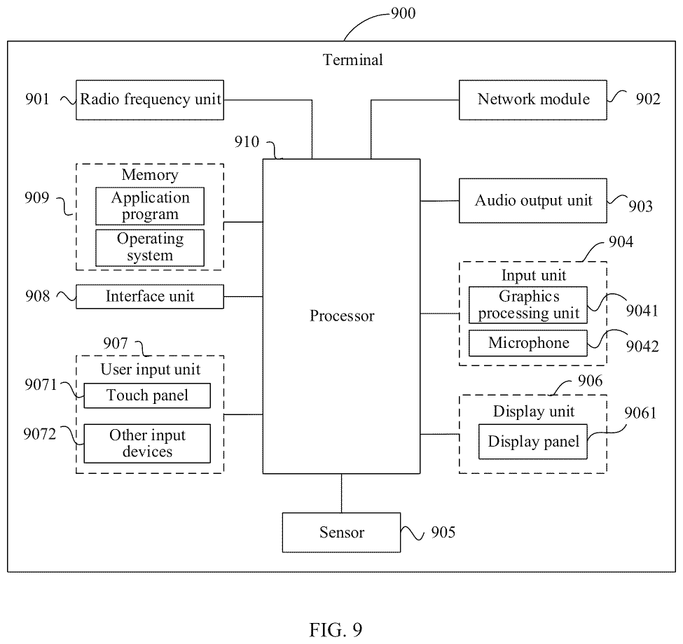

An embodiment of this application further provides a terminal including a processor and a communication interface, where the communication interface is configured to receive DRX configuration information of a wake-up signal WUS; and the processor is configured to perform, based on the DRX configuration information, WUS monitoring during DRX on duration. This terminal embodiment corresponds to the foregoing terminal-side method embodiment. All implementation processes and implementations of the foregoing method embodiment are applicable to this terminal embodiment. FIG. 9 is a schematic diagram of a hardware structure of a terminal implementing the embodiments of this application.

The terminal 900 includes but is not limited to at least some of a radio frequency unit 901, a network module 902, an audio output unit 903, an input unit 904, a sensor 905, a display unit 906, a user input unit 907, an interface unit 908, a memory 909, and a processor 910.

Persons skilled in the art can understand that the terminal 900 may further include a power supply (for example, a battery) supplying power to the components, and the power supply may be logically connected to the processor 910 through a power management system, so as to implement functions such as charging management, discharging management, and power consumption management by using the power management system. The structure of the terminal shown in FIG. 9 does not constitute any limitation on the terminal. The terminal may include more or fewer components than shown in the figure, or a combination of some components, or the components disposed differently. Details are not described herein again.

It can be understood that in this embodiment of this application, the input unit 904 may include a Graphics Processing Unit (GPU) 9041 and a microphone 9042. The graphics processing unit 9041 processes image data of a still picture or video obtained by an image capture apparatus (such as a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and other input devices 9072. The touch panel 9071 is also referred to as a touchscreen. The touch panel 9071 may include two parts: a touch detection apparatus and a touch controller. The other input devices 9072 may include but are not limited to a physical keyboard, a function key (such as a volume control key or an on/off key), a trackball, a mouse, and a joystick. Details are not described herein.

In this embodiment of this application, after receiving downlink data from the network-side device, the radio frequency unit 901 can transmit the downlink data to the processor 910 for processing. In addition, the radio frequency unit 901 can send uplink data to the network-side device. In some implementations, the radio frequency unit 901 includes but is not limited to an antenna, an amplifier, a transceiver, a coupler, a low noise amplifier, and a duplexer.

The memory 909 may be configured to store a software program or instructions and various data. The memory 909 may mainly include a first storage area for storing programs or instructions and a second storage area for storing data. The first storage area may store an operating system, an application program or instructions required by at least one function (for example, a sound play function or an image play function), and the like. Additionally, the memory 909 may include a volatile memory or a non-volatile memory, or the memory 909 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), or a Direct Rambus RAM (DRRAM). The memory 909 in this embodiment of this application includes but is not limited to these and any other suitable types of memory.

The processor 910 may include one or more processing units. In some implementations, the processor 910 integrates an application processor and a modem processor. The application processor primarily processes operations involving an operating system, a user interface, an application program, or the like. The modem processor primarily processes radio communication signals, for example, being a baseband processor. It can be understood that the modem processor may be not integrated into the processor 910.

The radio frequency unit 901 is configured to receive DRX configuration information of a wake-up signal WUS.

The processor 910 is configured to perform, based on the DRX configuration information, WUS monitoring during DRX on duration.

The DRX configuration information includes at least one of the following:
DRX start point configuration information;
DRX on duration configuration information; and
DRX cycle configuration information.

In some implementations, the DRX start point configuration information includes at least one of the following:
a system frame;
a superframe, where the superframe includes N system frames, N being an integer greater than or equal to 1;
extended discontinuous reception eDRX configuration information for paging;
a related parameter of connected mode discontinuous reception C-DRX for the terminal; and
a related parameter of a physical downlink control channel PDCCH that the terminal needs to monitor.

In some implementations, in a case that the DRX start point configuration information includes a system frame, the processor 910 is further configured to:
determine a DRX start point based on at least one of a specific system frame and a first time offset, and perform WUS monitoring during the DRX on duration based on the DRX start point; where
a start point of the first time offset is a start point or an end point of the specific system frame.

In some implementations, a time unit of the first time offset includes at least one of the following: subframe, slot, symbol, millisecond, system frame, and superframe.

In some implementations, the eDRX configuration information includes at least one of the following:
a start point or an end point of an eDRX cycle;
a start point or an end point of a paging time window PTW within the eDRX cycle;
a paging frame within the PTW;
a paging occasion within the paging frame within the PTW; and
a start point or an end point of a superframe in which the paging occasion is located.

In some implementations, in a case that the DRX start point configuration information includes the eDRX configuration information, the processor 910 is further configured to:
determine a first start point of DRX based on the eDRX configuration information, and perform WUS monitoring during the DRX on duration based on the first start point.

In some implementations, the processor 910 is further configured to: adjust the first start point of the DRX to a second start point based on a second time offset, and perform WUS monitoring during the DRX on duration based on the second start point.

In some implementations, a time unit of the second time offset includes at least one of the following: quantity of the eDRX cycles, slot, symbol, millisecond, frame, and superframe.

In some implementations, the related parameter of the C-DRX for the terminal includes at least one of the following:
a start point of the DRX on duration;
a long DRX cycle; and
a short DRX cycle.

In some implementations, the related parameter of the PDCCH that the terminal needs to monitor includes at least one of the following:
a time position of a search space in which the PDCCH is located; and
a cycle of the search space in which the PDCCH is located.

In some implementations, different WUS types are associated with respective DRX configuration information.

In some implementations, the processor 910 is further configured to:
determine, based on a WUS type, DRX configuration information associated with the WUS type.

In some implementations, the WUS type is associated with at least one of the following: a WUS sequence, a WUS format, a WUS frame structure, and a WUS-occupied band.

In some implementations, the DRX configuration information of the WUS includes configuration information of at least one DRX of the WUS, and a quantity of configuration information of the at least one DRX is related to a terminal capability of the terminal.

In some implementations, the processor 910 is further configured to:
perform, based on the configuration information of the at least one DRX, WUS monitoring during on duration of the at least one DRX.

In some implementations, the radio frequency unit 901 is further configured to:
send assistance information to a network-side device, where the assistance information includes DRX configuration information of the WUS preferred by the terminal.

In this embodiment of this application, the terminal performs, based on the DRX configuration information of the received WUS, WUS monitoring during the DRX on duration, with no need for the terminal to stay in a monitoring state, thereby effectively reducing power consumption of the terminal.

An embodiment of this application further provides a network-side device including a processor and a communication interface, where the communication interface is configured to send DRX configuration information of a WUS to a terminal. The network-side device embodiment corresponds to the foregoing method embodiment on the network-side device side. All implementation processes and implementations of the foregoing method embodiment are applicable to this network-side device embodiment.

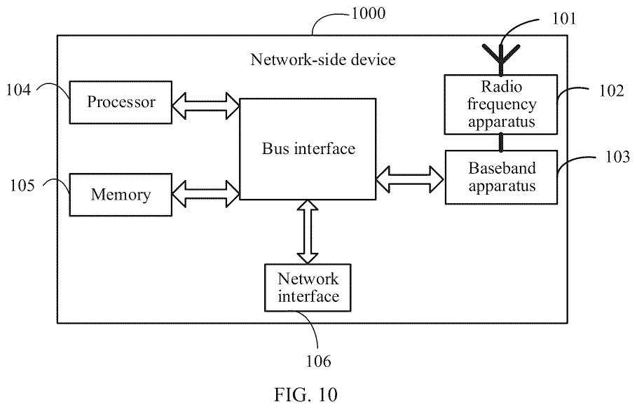

An embodiment of this application further provides a network-side device. As shown in FIG. 10, the network-side device 1000 includes an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information via the antenna 101, and sends the received information to the baseband apparatus 103 for processing. In a downlink direction, the baseband apparatus 103 processes to-be-sent information, and sends the information to the radio frequency apparatus 102; and the radio frequency apparatus 102 processes the received information and then sends the information out via the antenna 101.

The method executed by the network-side device in the above embodiment can be implemented in the baseband apparatus 103, and the baseband apparatus 103 includes a baseband processor.

The baseband apparatus 103 may include, for example, at least one baseband processing unit, where a plurality of chips are disposed on the baseband processing unit. As shown in FIG. 10, one of the chips is, for example, the baseband processor, and connected to the memory 105 via a bus interface, to invoke the program in the memory 105 to perform the operations of the network device shown in the foregoing method embodiment.

The network-side device may further include a network interface 106. The interface is, for example, a Common Public Radio Interface (CPRI).

The network-side device 1000 in this embodiment of the present application further includes: instructions or a program stored in the memory 105 and capable of running on the processor 104. The processor 104 invokes the instructions or program in the memory 105 to execute the method executed by the modules shown in FIG. 7. To avoid repetition, details are not described herein again.

An embodiment of this application further provides a readable storage medium, where a program or instructions are stored on the readable storage medium, and when the program or instructions are executed by a processor, various processes of the method embodiment described in FIG. 3 are implemented, or various processes of the method embodiment described in FIG. 5 are implemented. To avoid repetition, details are not described herein again.

The processor is a processor in the terminal described in the foregoing embodiment. The readable storage medium includes a computer-readable storage medium, such as a computer read-only memory ROM, a random access memory RAM, a magnetic disk, or an optical disc.

An embodiment of this application further provides a chip, where the chip includes a processor and a communication interface, the communication interface is coupled to the processor, and the processor is configured to run a program or instructions to implement various processes of the method embodiment described in FIG. 3, or to implement various processes of the method embodiment described in FIG. 5. To avoid repetition, details are not described herein again.

It should be understood that the chip mentioned in this embodiment of this application may also be referred to as a system-level chip, a system chip, a chip system, a system-on-chip, or the like.

An embodiment of this application further provides a computer program/program product, where the computer program/program product is stored in a storage medium, and the computer program/program product is executed by at least one processor to implement various processes of the method embodiment described in FIG. 3, or to implement various processes of the method embodiment described in FIG. 5. To avoid repetition, details are not described herein again.

An embodiment of this application further provides a communication system including a terminal and a network-side device, where the terminal may be configured to perform the steps of the method described in FIG. 3, and the network-side device may be configured to perform the steps of the method described in FIG. 5.

It should be noted that in this specification, the terms “include” and “comprise,” or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may understand that the method in the foregoing embodiment may be implemented by software with a necessary general hardware platform. Certainly, the method in the foregoing embodiment may also be implemented by hardware. Based on such an understanding, the technical solutions of the present application essentially or the part contributing to the prior art may be implemented in a form of a software product. The software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this disclosure.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A Discontinuous Reception (DRX) parameter configuration method, performed by a terminal, comprising:
receiving DRX configuration information of a Wake-Up Signal (WUS); and
performing, based on the DRX configuration information, WUS monitoring during DRX on duration, wherein
the DRX configuration information comprises at least one of the following:
DRX start point configuration information;
DRX on duration configuration information; or
DRX cycle configuration information.

2. The method according to claim 1, wherein the DRX start point configuration information comprises at least one of the following:
a system frame;
a superframe, wherein the superframe comprises N system frames, N being an integer greater than or equal to 1;
extended Discontinuous Reception eDRX configuration information for paging;
a related parameter of Connected mode Discontinuous Reception (C-DRX) for the terminal; or
a related parameter of a Physical Downlink Control CHannel (PDCCH) that the terminal is configured to monitor.

3. The method according to claim 2, wherein the performing, based on the DRX configuration information, WUS monitoring during DRX on duration comprises:
when the DRX start point configuration information comprises a system frame, determining a DRX start point based on at least one frame of the system frame or a first time offset, and performing WUS monitoring during the DRX on duration based on the DRX start point; wherein
a start point of the first time offset is a start point or an end point of the one frame of the system frame.

4. The method according to claim 2, wherein the eDRX configuration information comprises at least one of the following:
a start point or an end point of an eDRX cycle;
a start point or an end point of a Paging Time Window (PTW) within the eDRX cycle;
a paging frame within the PTW;
a paging occasion within the paging frame within the PTW; or
a start point or an end point of a superframe in which the paging occasion is located.

5. The method according to claim 4, wherein the performing, based on the DRX configuration information, WUS monitoring during DRX on duration comprises:
when the DRX start point configuration information comprises the eDRX configuration information, determining a first start point of DRX based on the eDRX configuration information, and performing WUS monitoring during the DRX on duration based on the first start point.

6. The method according to claim 5, further comprising:
adjusting, based on a second time offset, the first start point of the DRX to a second start point, and performing WUS monitoring during the DRX on duration based on the second start point.

7. The method according to claim 2, wherein the related parameter of the PDCCH that the terminal monitors comprises at least one of the following:
a time position of a search space in which the PDCCH is located; or
a cycle of the search space in which the PDCCH is located.

8. The method according to claim 1, wherein different WUS types are associated with respective DRX configuration information.

9. The method according to claim 8, wherein before the performing, based on the DRX configuration information, WUS monitoring during DRX on duration, the method further comprises:
determining, based on a WUS type, DRX configuration information associated with the WUS type.

10. The method according to claim 8, wherein the WUS type is associated with at least one of the following: a WUS sequence, a WUS format, a WUS frame structure, or a WUS-occupied band.

11. The method according to claim 1, wherein the DRX configuration information of the WUS comprises configuration information of at least one DRX of the WUS, and a quantity of configuration information of the at least one DRX is related to a terminal capability of the terminal.

12. The method according to claim 11, wherein the performing, based on the DRX configuration information, WUS monitoring during DRX on duration comprises:
performing, based on the configuration information of the at least one DRX, WUS monitoring during on duration of the at least one DRX.

13. The method according to claim 1, before the receiving, DRX configuration information of a WUS, the method further comprises:
sending, assistance information to a network-side device, wherein the assistance information comprises DRX configuration information of the WUS indicated by the terminal.

14. A terminal, comprising:
a memory storing computer-readable instructions; and
a processor coupled to the memory and configured to execute the computer-readable instructions, wherein the computer-readable instructions, when executed by the processor, cause the processor to perform operations comprising:
receiving Discontinuous Reception (DRX) configuration information of a Wake-Up Signal (WUS); and
performing, based on the DRX configuration information, WUS monitoring during DRX on duration, wherein
the DRX configuration information comprises at least one of the following:
DRX start point configuration information;
DRX on duration configuration information; or
DRX cycle configuration information.

15. The terminal according to claim 14, wherein the DRX start point configuration information comprises at least one of the following:
a system frame;
a superframe, wherein the superframe comprises N system frames, N being an integer greater than or equal to 1;
extended Discontinuous Reception eDRX configuration information for paging;
a related parameter of Connected mode Discontinuous Reception (C-DRX) for the terminal; or
a related parameter of a Physical Downlink Control CHannel (PDCCH) that the terminal is configured to monitor.

16. The terminal according to claim 15, wherein the performing, based on the DRX configuration information, WUS monitoring during DRX on duration comprises:
when the DRX start point configuration information comprises a system frame, determining a DRX start point based on at least one frame of the system frame or a first time offset, and performing WUS monitoring during the DRX on duration based on the DRX start point; wherein
a start point of the first time offset is a start point or an end point of the one frame of the system frame.

17. The terminal according to claim 15, wherein the eDRX configuration information comprises at least one of the following:
a start point or an end point of an eDRX cycle;
a start point or an end point of a Paging Time Window (PTW) within the eDRX cycle;
a paging frame within the PTW;
a paging occasion within the paging frame within the PTW; or
a start point or an end point of a superframe in which the paging occasion is located.

18. The terminal according to claim 17, wherein the performing, based on the DRX configuration information, WUS monitoring during DRX on duration comprises:
when the DRX start point configuration information comprises the eDRX configuration information, determining a first start point of DRX based on the eDRX configuration information, and performing WUS monitoring during the DRX on duration based on the first start point.

19. The terminal according to claim 18, wherein the operations further comprise:
adjusting, based on a second time offset, the first start point of the DRX to a second start point, and performing WUS monitoring during the DRX on duration based on the second start point.

20. A non-transitory computer-readable medium storing instructions that, when executed by a processor, cause the processor to perform operations comprising:
receiving Discontinuous Reception (DRX) configuration information of a Wake-Up Signal (WUS); and
performing, based on the DRX configuration information, WUS monitoring during DRX on duration, wherein
the DRX configuration information comprises at least one of the following:
DRX start point configuration information;
DRX on duration configuration information; or
DRX cycle configuration information.
